(19) United States
(12) Patent Application Publication
(10) Pub. No.: US 2023/0191340 A1
(43) Pub. Date: Jun. 22, 2023

(54) SUPERHYDROPHOBIC MEMBRANES AND METHODS OF MAKING AND USING SAME

(71) Applicants: Saudi Arabian Oil Company, Dhahran (SA); King Fahd University of Petroleum & Minerals, Dhahran (SA)

(72) Inventors: Turki Nabieh Baroud, Dhahran (SA); Hasan Al Abdulgader, Dhahran (SA); Young Chul Choi, Dhahran (SA); Umair Baig, Dhahran (SA); Mohammed Abdul Azeem, Dhahran (SA)

(21) Appl. No.: 17/645,203

(22) Filed: Dec. 20, 2021

(51) Int. Cl. B01D 71/34; C02F 1/44; B01D 69/02; B01D 67/00

(52) U.S. Cl. CPC B01D 71/34; B01D 67/0016; B01D 67/0095; B01D 69/02; C02F 1/447; C02F 2103/08

(57) ABSTRACT

The disclosure relates to superhydrophobic membranes and methods of making and using such membranes. Polydimethylsiloxane (PDMS) substrate is formed on sandpaper such that the PDMS substrate has a surface texture replicating the opposite impression of the sandpaper texture. Separately, a PVDF solution is prepared and disposed on the PDMS substrate. The PVDF substrate and liquid film combination are transferred to a solution of deionized water mixed with 2-propanol to form a PVDF film on the PDMS substrate. The PVDF film-PDMS substrate is transferred to a second DI water bath, after which the PVDF film is detached from the PDMS substrate. The PVDF film is then washed and dried, to yield a superhydrophobic PVDF membrane having the texture of sandpaper.

### FIELD

The disclosure relates to superhydrophobic membranes and methods of making and using such membranes.

### BACKGROUND

There is an increasing demand for freshwater. This has helped the development of various distillation technologies. Membrane distillation is an example of such a technology. In certain implementations, membrane distillation involves flowing a relatively hot feed stream along one side of a porous (e.g., microporous or mesoporous) and hydrophobic membrane while counter-flowing a relatively cool permeate stream along the opposite side of the membrane. The temperature difference between the two streams results in a partial pressure difference across the membrane. The partial pressure difference and the porous nature of the membrane allow water vapor to pass across the membrane from the relatively hot feed stream to the relatively cool permeate stream, where the water condenses to form liquid water in the permeate stream. At the same time, the hydrophobic nature of the membrane generally stops liquid water from passing directly through the membrane. The net result is a transfer of water from the feed stream to the permeate stream.

### SUMMARY

The disclosure relates to superhydrophobic membranes and methods of making and using such membranes. An example of such a membrane is a porous and hydrophobic polymer membrane having surface characteristics that enhance the performance of the membrane when used, for example, in membrane distillation processes, such water desalination. In general, the membrane can exhibit relatively high hydrophobicity, relatively high liquid entry pressure (LEP), relatively high permeability, relatively low fouling rate, relatively good thermal stability, relatively good chemical stability, relatively good mechanical strength, and/or relatively good long-term performance. The membranes can have a relatively low surface energy, a desirable surface roughness and/or a desirable surface texture. The membranes can have relatively durable (long lasting) surface properties. The membranes can have surface properties that lend themselves to being used as an anchorage for depositing materials, such as, for example, nanoparticles, fluorinated particles and coatings.

The methods of making the membranes can be relatively simple and/or relatively inexpensive. The methods can allow for good scalable and/or good commercial viability. The methods can provide enhanced flexibility, such as with respect to the ability to tailor the properties of the template used when making a membrane. In some embodiments, the methods include using a first material, e.g., polydimethylsiloxane (PDMS), as template for the membrane which is made of a different polymer, e.g., polyvinylidenedifluoride (PVDF). The membrane, e.g., a PVDF membrane, can have surface properties that are substantially the same as those of the template, e.g., a PDMS template, used to form the membrane. In certain embodiments, the template for making the membrane is itself made using a template of a different material, such as sandpaper. In such embodiments, the surface properties of the membrane, e.g., a PVDF membrane, can be substantially the same as those of the initial template, e.g., sandpaper.

In general, the membrane can be used in any desired method of use. For example, the membrane can be broadly use in various separation methods. In some embodiments, the membrane can be used in membrane distillation, such as direct contact membrane distillation, vacuum membrane distillation, air gap membrane distillation, and sweeping gas membrane distillation.

In an aspect, the disclosure provides a method that includes using a surface of a first material as a substrate to form a PDMS substrate, and using a surface of the PDMS substrate as a substrate to form a porous and hydrophobic polymer membrane. At least one of the following holds: the surface of the first material has a grit of from 240 to 600; the surface of the first material has an Rₐ value from 0.2 µm to 1.5 µm; the surface of the first material has an R_{q} value from 0.5 µm to 2 µm; and the surface of the first material has an R_{z} value 2.5 µm to 8 µm.

The method can further include forming the PDMS substrate on the surface of the first material, and removing the PDMS substrate from the surface of the first material.

The method can further include disposing a hydrophobic polymer and a LiCl in DMF to form a suspension, and disposing the suspension on a surface of the PDMS substrate to provide a first intermediate product. The suspension can include from 13% to 17% PVDF, and from 4% to 5% pore former.

The method can further include disposing the first intermediate product in a solution including water and isopropanol to provide a second intermediate product. The solution can include from 20% to 30% alcohol.

The method can further include disposing the second intermediate product in water to form a solid polymer film on the PDMS substrate.

The method can further include: disposing PVDF and LiCl in DMF to form a suspension, the suspension including from 13% to 17% PVDF and from 3% to 4% LiCl; disposing the suspension on the PDMS substrate to provide a first intermediate product; and disposing the first intermediate product a solution including water and from 20% to 30% isopropanol to provide a second intermediate product.

The first material can be sandpaper.

At least one of the following can hold for a surface of the membrane: the surface of the membrane has a grit of from 240 to 600; the surface of the membrane has an Rₐ value from 0.2 µm to 1.5 µm; the surface of the membrane has an R_{q} value from 0.5 µm to 2 µm; and the surface of the membrane has an R_{z} value 2.5 µm to 8 µm .

At least one of the following can hold: the membrane includes pores, and the pores have an average size of from 0.15 µm to 0.45 µm; the membrane includes a surface having a static water contact angle of from 147° to 155°; the membrane includes a surface having a sliding angle of from 10° to 15°; the membrane has a liquid entry pressure of from 1.8 bar to 2.5 bar; the membrane has a thickness of from 140 µm to 170 µ; the membrane has a permeate flux of from 12 Lm-2h-1 to 25 Lm-2h-1 according to the AGDM test; the membrane has a salt rejection of at least 99.7% at five hours; and the membrane has a permeate TDS of from 3 ppm to 100 ppm.

The method can further include forming a membrane from the PVDF film, and using the membrane in a membrane distillation process. The membrane distillation process can be direct contact membrane distillation, air gap membrane distillation, sweeping gas membrane distillation, vacuum gap membrane distillation, permeate gap membrane distillation, and/or vacuum multi-effect membrane distillation. The method can further include using the membrane distillation process to treat produced water. The method can further include using the membrane distillation process to treat produced water via an air gap membrane desalination process.

In an aspect, the disclosure provides a method that includes: disposing a liquid including PDMS on a surface of sandpaper; curing the PDMS to form a sheet of solidified PDM on the surface of the sandpaper; removing the PDMS sheet from the sandpaper; dissolving PVDF and LiCl in DMF to form a solution; disposing the solution on a surface of the PDMS sheet to provide a first intermediate product; and disposing the first intermediate product in a solution including water and from 20% to 30% isopropanol to form solidified PVDF on the PDMS sheet.

The method can further include disposing the solidified PVDF-PDMS sheet in water, and, after disposing the solidified PVDF in water, removing the solidified PVDF from the PDMS sheet.

The solution can include from 13% to 17% PVDF, and from 4% to 5% LiCl.

At least one of the following can hold for a surface of the solidified PVDF: the surface of the solidified PVDF has a grit of from 240 to 600; the surface of the solidified PVDF has an Rₐ value from 0.2 µm to 1.5 µm; the surface of the solidified PVDF has an R_{q} value from 0.5 µm to 2 µm; and the surface of the solidified PVDF has an R_{z} value 2.5 µm to 8 µm.

At least one of the following can hold: the solidified PVDF includes pores, and the pores have an average size of from 0.15 µm to 0.45 µm; the solidified PVDF includes a surface having a static water contact angle of from 147° to 155°; the solidified PVDF includes a surface having a sliding angle of from 10° to15°; the solidified PVDF has a liquid entry pressure of from 1.8 bar to 2.5 bar; the solidified PVDF has a thickness of from 140 µm to 170 µ; the solidified PVDF has a permeate flux of from 12 Lm-2h-1 to 25 Lm-2h-1 according to the AGDM test; the solidified PVDF has a salt rejection of at least 99.7% at five hours; and the solidified PVDF has a permeate TDS of from 3 ppm to 100 ppm.

In an aspect, the disclosure provides a method, including: forming a PDMS substrate on a surface of sandpaper; disposing a hydrophobic polymer and PVP in DMF to form a solution; and disposing the solution on a surface of the PDMS substrate to provide a first intermediate product; and disposing the first intermediate product in a substantially water-free alcohol solution to provide a second intermediate product.

The hydrophobic polymer can include PVDF.

The suspension can include from 13% to 17% PVDF, and from 4% to 7% pore former.

The alcohol can be ethanol, isopropanol and/or methanol.

The method can further include disposing the second intermediate product in water to form a solid hydrophobic polymer film on the PDMS substrate.

The method can further include removing the solid hydrophobic polymer film from the PDMS substrate to provide a membrane including the solid hydrophobic polymer.

At least one of the following can hold: the surface of a surface of the membrane has a grit that is substantially the same as a grit of the surface of the sandpaper; the surface of a surface of the membrane has an Ra value that is substantially the same as an Ra of the surface of the sandpaper; the surface of a surface of the membrane has an Rq value that is substantially the same as an Rq of the surface of the sandpaper; and the surface of a surface of the membrane has an Rz that is substantially the same as an Rz value of the surface of the sandpaper.

At least one of the following can hold: the polymer film includes pores, and the pores have an average size of from 0.1 µm to 0.3 µm; the polymer film includes a surface having a static water contact angle of from 143° to 151°; the polymer film has a liquid entry pressure of from 1.4 bar to 2.25 bar; and the polymer film has a thickness of from 290 µm to 380 µm.

The second intermediate produce can include a solid sheet of the hydrophobic polymer, and the method further includes forming a porous membrane of the hydrophobic polymer.

The method can further include disposing the PVDF film in a membrane distillation module.

The method can further include using the membrane distillation module in a method selected from the group consisting of direct contact membrane distillation, air gap membrane distillation, sweeping gas membrane distillation, vacuum gap membrane distillation, permeate gap membrane distillation and vacuum multi-effect membrane distillation.

The method can further include using the membrane distillation module to treat produced water.

The method can further include using the membrane to treat produced water via an air gap membrane desalination process.

In an aspect, the disclosure provides a method, including: disposing PDMS on a surface of sandpaper to use the surface of the sandpaper as a substrate to form a PDMS substrate; solidifying the PDMS on the surface of the sandpaper; removing the solidified PDMS substrate from the sandpaper so that the solidified PDMS has a surface that substantially matches the surface of the sandpaper; disposing PVDF and PVP in DMF to form a solution including from 13% to 17% PVDF and from 4% to 7% PVP; disposing the solution on the surface of the PDMS substrate to provide a first intermediate product; disposing the first intermediate product in substantially a water-free solution including an alcohol selected from the group consisting of ethanol, isopranol and methanol to provide a solidified PVDF film on the surface of the PDMS; disposing the PVDF film-PDMS in water; and after disposing the second intermediate product in water, removing the PVDF film from the PDMS to provide a PVDF sheet.

The method can further include washing and drying the PVDF sheet to provide a porous and hydrophobic PVDF membrane.

The method can further include using the membrane in a membrane distillation process.

The membrane distillation process can be direct contact membrane distillation, air gap membrane distillation, sweeping gas membrane distillation, vacuum gap membrane distillation, permeate gap membrane distillation and/or vacuum multi-effect membrane distillation.

### BRIEF DESCRIPTION OF THE DRAWINGS

FIG. 1 is a flow chart of a method of making a membrane.

FIGS. 2A-2D are photographs of membranes.

FIG. 3 schematically shows a lab scale AGMD experimental set-up.

FIGS. 4A-4H are scanning electron microscope (SEM) images of membranes.

FIGS. 5A-5D are cross-sectional SEM images of membranes.

FIGS. 6A-6D are atomic force microscope (AFM) images of membranes.

FIG. 7 shows measured roughness parameters of membranes based on AFM measurements.

FIG. 8 shows static water contact angle measurements of membranes.

FIGS. 9A-9D show images of a de-ionized (DI) water droplet on membrane.

FIGS. 10A and 10B show liquid entry pressure (LEP) and thickness measurements, respectively, for membranes.

FIGS. 11A and 11B show the permeate flux and the salt rejection, respectively, of membranes.

FIG. 12 shows the permeate total dissolved solids (TDS) measurement from the AGMD test for different membranes.

FIG. 13 shows surface wettability behavior of membranes.

FIG. 14 shows Fourier transfer infrared (FT-IR) spectra of membranes.

FIG. 15 shows FT-IR spectra of membranes.

FIG. 16a-16d3 show field emission scanning electron microscope (FE-SEM) images of membranes at different magnifications.

FIG. 17a-17d3 show FE-SEM images of membranes at different magnifications.

FIG. 18a-18d3 show FE-SEM images of membranes at different magnifications.

### DETAILED DESCRIPTION

### Membrane

In general, the membrane is a porous and hydrophobic polymer membrane having a desirable surface roughness and surface texture, as well as desirable separation properties.

In some embodiments, the membrane is a hydrophobic polymer membrane. Examples of hydrophobic polymers include polysulfone (PSF), polyethersulfone (PES), polyvinylidenedifluoride (PVDF), polyacrylonitrile (PAN), polytetrafluoroethylene (e.g., Teflon), polyamide-imide (PAI), polyimide (PIs), co-polyimide, polyethylene (PE), polypropylene (PP), cellulose acetate (CA), Polyetheretherketone (PEEK), polybenzimidazole (PBI) and modified forms of such polymers.

In certain embodiments, the membrane has an average pore size of from 0.15 µm to 0.45 µm (e.g., from 0.15 µm to 0.3 µm, from 0.25 µm to 0.45 µm). In some embodiments, the membrane has an average pore size of from 0.1 µm to 0.3 µm (e.g., from 0.2 µm to 0.3 µm, from 0.1 µm to 0.2 µm).

In some embodiments, the membrane has an average roughness (Ra) determined by AFM of from 0.2 µm to 1.5 µm (e.g., 0.2 µm to 1 µm, from 0.5 µm to 1.5 µm). In certain embodiments, the membrane has a root mean square roughness (Rq) determined by AFM of from 0.5 µm to 2 µm (e.g., from 0.75 µm to 2 µm, from 0.5 µm to 1.5 µm). In some embodiments, the membrane has an average profile height (Rz) determined by AFM of from 2.5 µm to 8 µm (e.g., from 4 µm to 8 µm, from 2.5 µm to 6 µm). In certain embodiments, the membrane has a grit of from 240 to 600. In some embodiments, the membrane has a grit of from 220 to 400.

In certain embodiments, the membrane has a static water contact angle of from 147° to 155° (e.g., from 147° to 150°, from 150° to 155°). In some embodiments, the membrane has a static water contact angle of from 143° to 151° (e.g., from 143° to 147°, from 147° to 151°). In certain embodiments, the membrane has a sliding angle of from 10° to 15° (e.g., from 10° to 12°, from 12° to 15°).

In some embodiments, the membrane has an LEP of from 1.8 bar to 2.5 bar (e.g., from 2 bar to 2.5 bar, from 1.8 bar to 2.2 bar) according to the LEP test described below. In certain embodiments, the membrane has an LEP of from 1.4 bar to 2.25 bar (e.g., from 1.8 bar to 2.25 bar, from 1.4 bar to 2.8 bar) according to the LEP test described below.

In certain embodiments, the membrane has a salt rejection of from 99.7% to 99.99% (e.g., from 99.8% to 99.99%, from 99.9% to 99.99%) at five hours according to the salt rejection test described below.

In some embodiments, the membrane has a permeate flux of from 12 Lm-2h-1 to 25 Lm-2h-1 (e.g., 17 Lm-2h-1 to 25 Lm-2h-1, 12 Lm-2h-1 to 17 Lm-2h-1) according to the AGMD test described below. In certain embodiments, the membrane can have a permeate flux of close to 40-50 Lm-2h-1 in other membrane distillation systems.

In certain embodiments, the membrane has a TDS of permeate of from 3 ppm to 100 ppm (e.g., from 25 ppm to 100 ppm, from 50 ppm to 100 ppm, from 3 ppm to 75 ppm, from 3 ppm to 50 ppm) according to the TDS test described below.

In some embodiments, the (dried) membrane is from 140 µm to 170 µm (e.g., from 155 µm to 170 µm, from 140 µm to 155 µm) thick. In certain embodiments, the membrane is from 290 µm to 380 µm (e.g., from 330 µm to 380 µm, from 290 µm to 330 µm) thick.

### Method of Making the Membrane

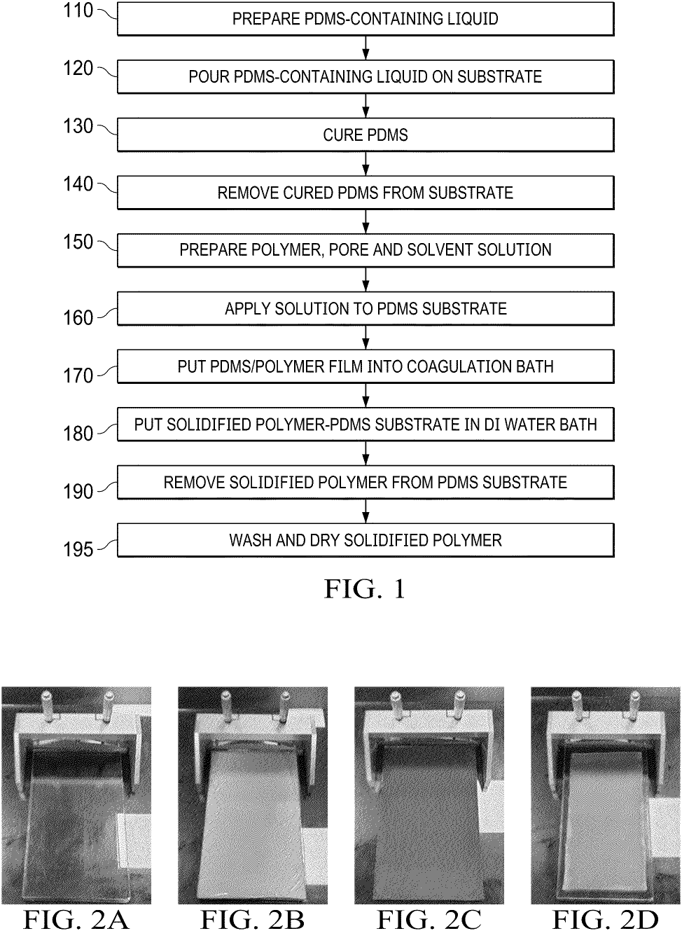

FIG. 1 is a flow chart showing the steps used to make a membrane according to certain embodiments.

In step 110, a PDMS-containing liquid is prepared. For example, an appropriate amount of PDMS and a curing agent are mixed, followed by and degassing.

In step 120, the PDMS/curing agent liquid is poured onto the surface of a substrate having appropriate surface properties to form a PDMS-containing gel layer. In some embodiments, the substrate is sandpaper. In certain embodiments, a different material having appropriate surface properties can be used, such as sandblasted or sanded metallic or non-metallic substrates. In some embodiments, the substrate has an average roughness (Ra) determined by AFM of from 0.2 µm to 1.5 µm (e.g., 0.2 µm to 1 µm, from 0.5 µm to 1.5 µm). In certain embodiments, the substrate has a root mean square roughness (Rq) determined by AFM of from 0.5 µm to 2 µm (e.g., from 0.75 µm to 2 µm, from 0.5 µm to 1.5 µm). In some embodiments, the substrate has an average profile height (Rz) determined by AFM of from 2.5 µm to 8 µm (e.g., from 4 µm to 8 µm, from 2.5 µm to 6 µm). In certain embodiments, the substrate has a grit of from 240 to 600. In some embodiments, the substrate has a grit of from 220 to 400.

In step 130, the gel is cured to solidify the PDMS. In some embodiments, curing occurs in an oven at an appropriate temperature (e.g., 80° C.) for an appropriate period of time (e.g., four hours) to form a solidified PDMS template.

In step 140, the solidified PDMS is removed from the substrate. The surface of the PDMS has properties that are substantially the same as those of the substrate. In some embodiments, the PDMS has an average roughness (Ra) determined by AFM of from 0.2 µm to 1.5 µm (e.g., 0.2 µm to 1 µm, from 0.5 µm to 1.5 µm). In certain embodiments, the PDMS has a root mean square roughness (Rq) determined by AFM of from 0.5 µm to 2 µm (e.g., from 0.75 µm to 2 µm, from 0.5 µm to 1.5 µm). In some embodiments, the PDMS has an average profile height (Rz) determined by AFM of from 2.5 µm to 8 µm (e.g., from 4 µm to 8 µm, from 2.5 µm to 6 µm). In certain embodiments, the PDMS has a grit of from 240 to 600. In some embodiments, the PDMS has a grit of from 220 to 400. In certain embodiments, the PDMS is from 2 µm to 6 µm (e.g., from 2 µm to 4 µm, from 4 µm to 6 µm) thick.

In step 150, a solution is prepared that contains the membrane polymer, a pore former and a solvent. In some embodiments, the membrane polymer is provided as a powder, e.g., a powder of PVDF. Typically, the membrane polymer and the pore former are dissolved thoroughly in the solvent. An example of a pore former is lithium chloride (LiCl). Another example of a pore former is polyvinylpyrrolidone (PVP). An example of a solvent is N, N-Dimethylformamide (DMF). In some embodiments PVDF powder and LiCl are thoroughly dissolved in DMF to provide the solution. The solution can include, for example, from 13% to 17% (e.g., from 13% to 15%, from 15% to 17%) PVDF powder, and/or from 4% to 5% (e.g., from 4% to 4.5%, from 4.5% to 5%) LiCl. In certain embodiments, PVDF powder and PVP are thoroughly dissolved in DMF to provide the solution. The solution can include, for example, from 13% to 17% (e.g., from 13% to 15%, from 15% to 17%) PVDF powder, and/or from 4% to 7% (e.g., from 4% to 5.5%, from 5.5% to 7%) PVP.

In step 160, the solution is applied to the surface of the PDMS.

In step 170, the PDMS substrate with the film of the solution is disposed in a coagulation bath that contains the non-solvent. In some embodiments, such as when the pore former is LiCl, DI water and isopropanol are used as the non-solvent. For example, when the pore former is LiCl, the coagulation bath can include from 20% to 30% (e.g., from 20% to 25%, from 25% to 30%) isopropanol. In certain embodiments, such as when the pore former is PVP, the coagulation bath contains substantially water-free alcohol (alcohol with less than 1% water). For example, when the pore former is PVP, the coagulation bath can be formed of substantially water-free methanol, substantially water-free ethanol, or substantially water-free isopropanol. Generally, the coagulation bath is at a temperature of from 25° C. to 40° C. (e.g., 30° C.). In some embodiments, this step is performed for from 15 minutes to 20 minutes. In step 170, a solid sheet of the polymer is formed on the surface of the PDMS substrate.

In step 190, the solid polymer sheet-PDMS substrate is disposed in a DI water bath.

In step 890, the polymer membrane sheet is removed from the surface of the substrate.

In step 195, the polymer membrane is washed and dried to yield the polymer membrane.

### EXAMPLES

### I. DI Water With Isopropanol as the Non-Solvent

### IA. Membrane Preparation

Four different substrates for casting a PVDF membrane were chosen: 1) tempered glass; 2) stainless steel mesh (SSM); 3) sandpaper (SP); and 4) a flat PDMS sheet. 400 grit sandpaper and 10 µm stainless steel mesh were procured locally and cleaned thoroughly using ethanol before using them as substrates for casting membrane. The flat sheet PDMS substrate was made using a SYLGARD 184 elastomer solution purchased from DOW chemical. To develop the PDMS substrate, an appropriate amount of PDMS and curing agent were mixed manually in a 10:1 ratio and degassed under vacuum for one hour to remove bubbles from the mixture. A mold was prepared with sandpaper as the base for pouring the PDMS mixture and replicating the opposite imprint of sandpaper structure on PDMS. The mixture was carefully spread on sandpaper to form a four mm thick PDMS gel layer. This gel was cured in an oven at 80° C. for four hours to form a solidified PDMS template. Subsequently the sheet was detached with care from the sandpaper and cleaned thoroughly before using it as substrate for casting membranes.

The membranes were made using a NIPS method with PVDF as the membrane material. LiCl was the pore former. DMF was the solvent. DI water with isopropanol was the non-solvent. The source of the PVDF was PVDF powder with an average molecular weight of about 534,000 was purchased from Sigma-Aldrich (USA). The DMF had a purity greater than 99% and was purchased from Scientific Laboratory Supplies (UK). The LiCl had a purity greater than 99.98% and was purchased from Sigma-Aldrich (USA). The isopropanol had a purity of 99.8% and was purchased from PanReac-AppliChem (ITW Reagents).

Each membrane was fabricated using 15% PVDF powder and 5% LiCl dissolved thoroughly in DMF solvent using a magnetic stirrer. The resultant solution was stored at a warm temperature for 12 hours without mixing to remove any air bubbles. The bubble free polymer solution was spread on the different substrates manually using a doctor’s blade with a casting film thickness of 250 µm.FIGS. 2A-2D are photographs of a tempered glass substrate, a SSM substrate, a sandpaper substrate and a PDMS substrate, respectively, after being cleaned thoroughly and set flat using a doctor’s blade. The thin film formed on the substrate was quickly transported to a coagulation bath containing DI water with 20% propanol maintained at 30° C. The precipitated membrane sheet formed in the coagulation bath after 10 minutes was carefully removed and subsequently left in another DI water bath for 12 hours to remove residual LiCl and DMF. Subsequently, the wet membrane sheet was dried under filter papers at room temperature for at least 24 hours before using it for testing and characterization.

### IB. Membrane Characterization

The surface morphologies of the membranes were observed using a field emission scanning electron microscope FE-SEM (FEI Quanta 250 FEG, USA). The thickness of the membranes at several locations was measured using a precision measuring instrument (LITEMATIC VL-50A, Mitutoyo) to assure consistency for AGMD test. The LEP of the membranes was measured using a lab made apparatus that pressurizes a small chamber of water against a membrane. The hydrophobicity of the membranes was investigated using a contact angle measurement goniometer (DM-501, Kyowa Interface Science Co. Ltd, Japan). An atomic force microscope (AFM) (Agilent 5500, USA) was used to analyze the surface topography and roughness of all the membranes.

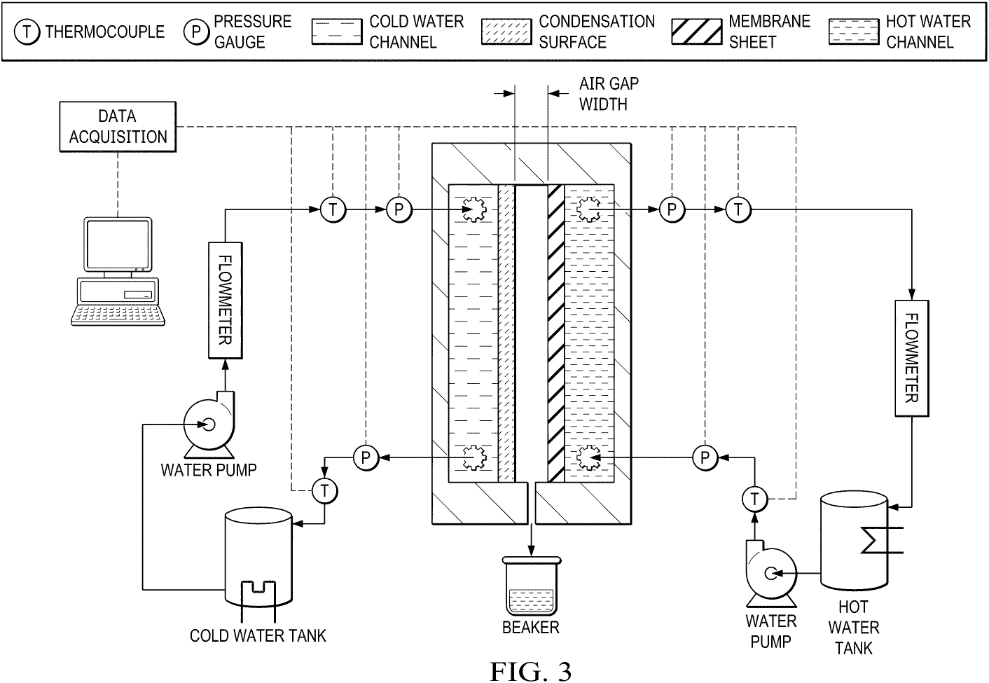

The performance of the PVDF membranes was evaluated using a lab scale AGMD experimental set-up, which is schematically shown in FIG. 3. The hot and cold channels were made of acrylic-plexiglas material with channel dimensions of 4 cm × 4 cm × 0.5 cm each. A high-density-poly-ethylene (HDPE) material was used as a support for the membrane sheet and also created an air gap width of five mm between the membrane surface and the condensation plate made of brass material. Each membrane was installed vertically inside the module and provided an effective membrane area of 7.316 × 10⁻⁴ m². A highly saline synthetic feed water of 70,000 ppm was prepared in the lab by dissolving 0.7 kg NaCl (99.8%, Chem-Lab, Belgium) in 10 L of DI (deionized) water. The saline water was heated to a temperature of 70 ± 0.7° C. and was supplied to the hot channel of the MD cell at 0.8 L/min, while the condensation plate was maintained at a temperature 20 ± 0.2° C. by chilled water supplied at 2 L/min. The textured PVDF membranes were tested for 300 minutes. The TDS and mass of the collected permeate was measured every 60 minutes using an Omega supplied CDH-287 micro conductivity meter and an A&D GF-3000 precision top loading weighing balance, respectively. The MD permeate flux ‘J’ in kgm-2h-1 was calculated using equation 1:

$$J = \frac{m}{{A}_{E} t}$$

where m, A_{E}and t were the mass of the collected permeate, the membrane effective area, and the time taken to collect the permeate, respectively. The salt rejection ‘R’ was calculated using the equation 2:

$$R = \left(\frac{{C}_{f} - {C}_{p}}{{C}_{f}}\right) x 100 \%$$

where C_{ƒ} and Cₚ are the feed and permeate salt concentrations, respectively.

### IC. Experimental Results

The substrates used were selected to duplicate the impression of substrates on the membrane during non-solvent induced phase separation process. Different textures were created in situ using stainless steel mesh, sandpaper and PDMS substrate. The PDMS replicated the opposite impression of sandpaper. Therefore the texture of the membrane cast on the PDMS substrate substantially resembled that of sandpaper texture. This was considered desirable because sandpaper is an abrasive material formed of SiC particles deposited on paper giving it a relatively rough and relatively spiky texture. This pattern could provide the lotus leaf texture on a membrane surface, which could enhance hydrophobicity. The SSM substrate with its woven wire pattern morphology and miniature openings also provided a rough pattern for texturing. The surface morphology and roughness of the PVDF membranes cast on glass, SSM, SP and PDMS substrates were compared using SEM and AFM.

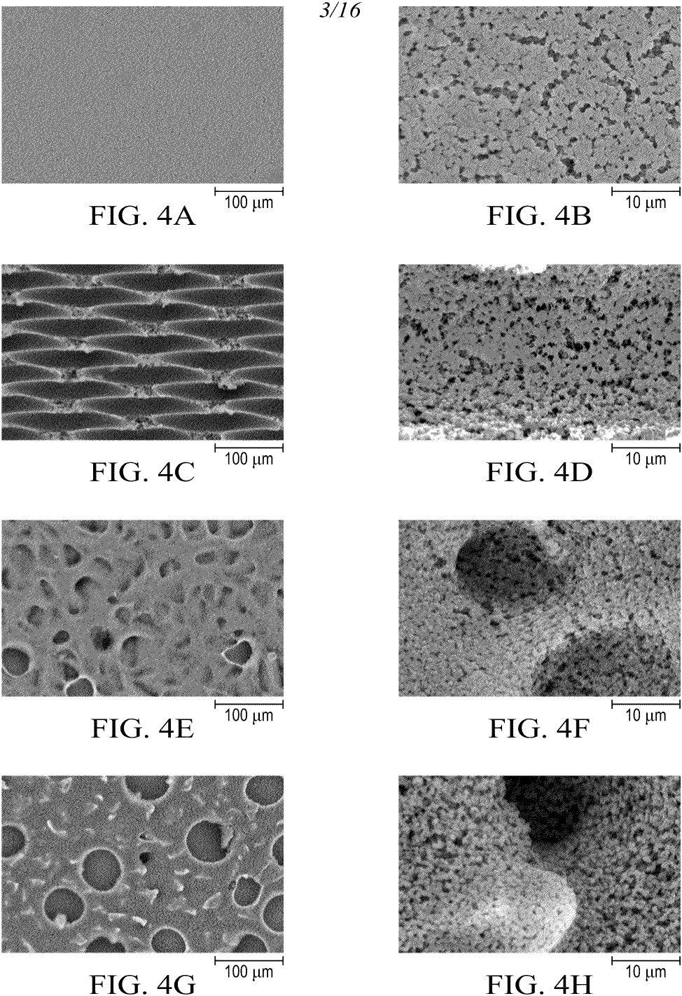

FIGS. 4A-4H are SEM images SEM images with low and high magnifications of PVDF membranes cast the following substrates: glass (3A, 3B) SSM (3C, 3D), sandpaper (3E, 3F), and PDMS (3G, 3H). FIG. 4A shows that the PVDF membrane cast on a glass substrate had a relatively flat surface with a crack like morphology at low magnification. However, as shown in FIG. 4B, at higher magnification the crack path actually represented the pore openings on the surface of the membrane. In contrast to the situation resulting from using a glass substrate, the SSM, sandpaper and PDMS substrates used in casting a PVDF membrane left typical textures on the membrane surface. FIG. 4C shows that the SSM-based membranes had a texture of a repeated wave-like pattern with dune like micro-peaks and wide micro-valleys. As explained by Zhao et al., “Hierarchically textured superhydrophobic polyvinylidene fluoride membrane fabricated via nanocasting for enhanced membrane distillation performance,” Desalination, vol. 443, no. April, pp. 228-236, 2018, doi: 10.1016/j.desal.2018.06.003., this texture provides a roughness for entrapping pockets of air and produces a superhydrophobic surface. Some tearing can be seen on the top of the peak due to peeling defects encountered in the preparation of the SSM substrate. FIG. 4D is the higher magnification image for SSM substrate sample, and shows a relatively good amount of pore opening due to the porous nature of SSM substrate. Referring to FIG. 4E, the sandpaper based membranes had a surface with an irregular texture including deep basins around a flat region. As show in FIG. 4F, which is the higher magnification image, more pore openings were observed due to the formation of basins in the membrane surface. FIGS. 4G and 4H show that the PDMS based membrane had a distinct surface morphology with craters surrounded with mounds of membrane material. This typical texture could potentially not only provide additional re-entrant structures but at the same time help in repelling the solutes in the feed solution. The mounds observed in the membrane resembles the sandpaper textures giving it a roughness to improve hydrophobicity. Moreover, for all the membranes, the SEM image at higher magnification showed submicron size pores on the surface.

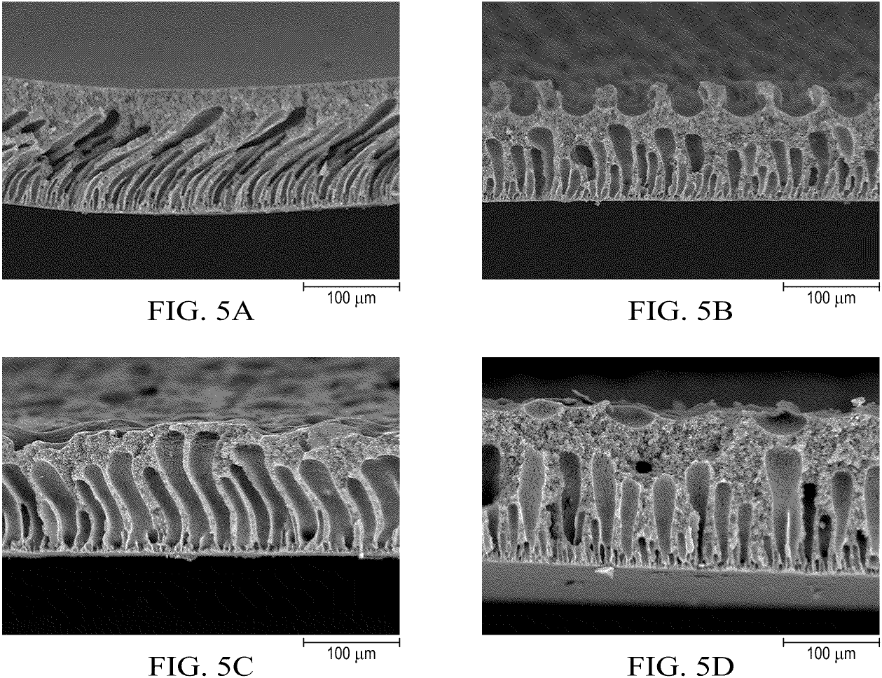

To view the cross-sections of the membranes under SEM, samples were prepared by carefully fracturing the membrane in liquid nitrogen. FIGS. 5A-5D show the SEM images. All the membranes showed an asymmetric structure characteristic for a membrane formed using the NIPS method. The demixing of DMF and the non-solvent during phase separation created a skin layer underside and a porous spongy layer on the top close to textured surface. Numerous re-entrant structures can be seen in FIGS. 5A-5D. The textured membrane formed using SSM, sandpaper and PDMS as the substrate showed a more porous structure due to the delayed demixing in the phase separation process, whereas the demixing on a glass substrate was relatively instantaneous, thus showing a relatively dense and relatively tortuous structure. Further, the membrane casted on glass showed a greater amount of curling and shrinking compared to other membranes.

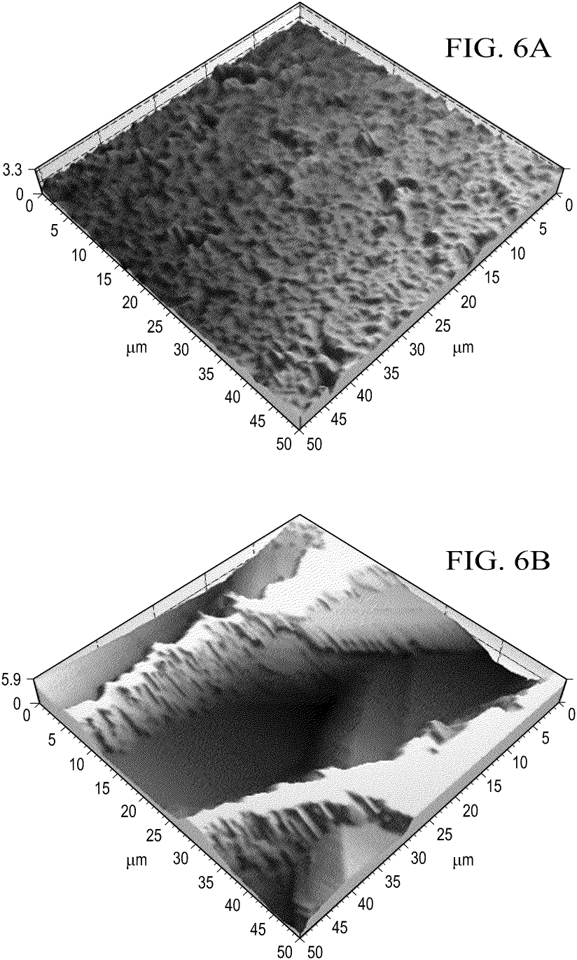

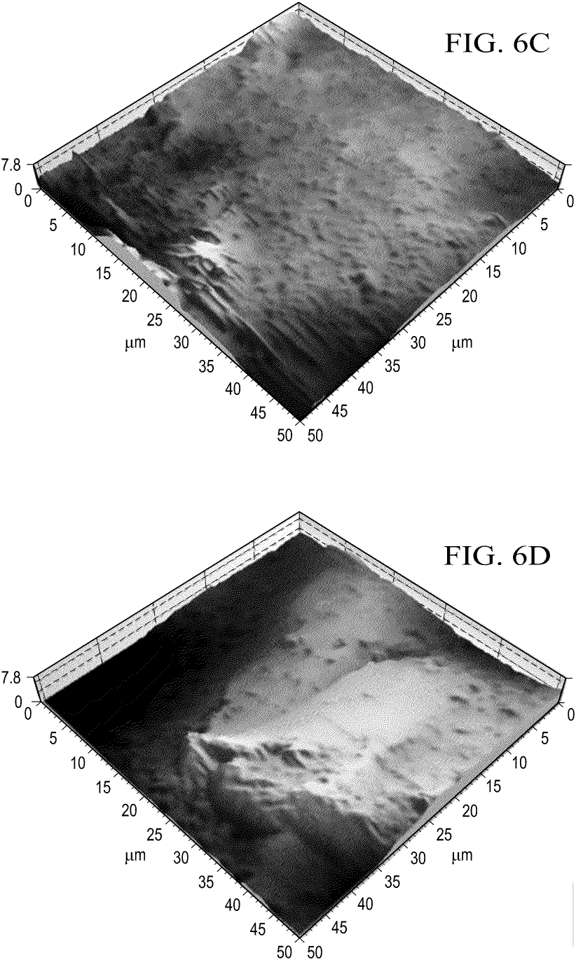

FIGS. 6A-6D are AFM images of the membrane made using a substrate formed of glass, SSM, sandpaper and PDMS, respectively. The images show the membrane texture and surface roughness of the membranes. The observed surface morphology of the different membrane surfaces under SEM was confirmed by AFM analysis. Typically, compared with the relatively flat glass substrate membrane, a sandpaper based membrane showed an increment in roughness while SSM and PDMS-based membranes obtained much higher roughness in terms of different roughness parameters (FIG. 7). The average roughness (Ra), root mean square roughness (Rq), and average profile height (Rz) are reported to quantify the textured surface. Rz denotes the variation in the highest peak and deepest valley in a membrane surface. The value of Rz which was found to be larger for SSM and PDMS based membranes.

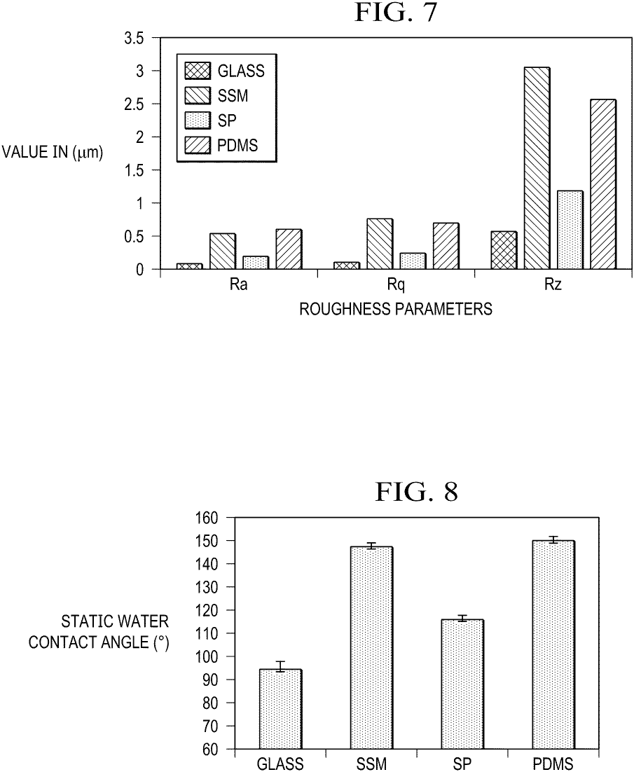

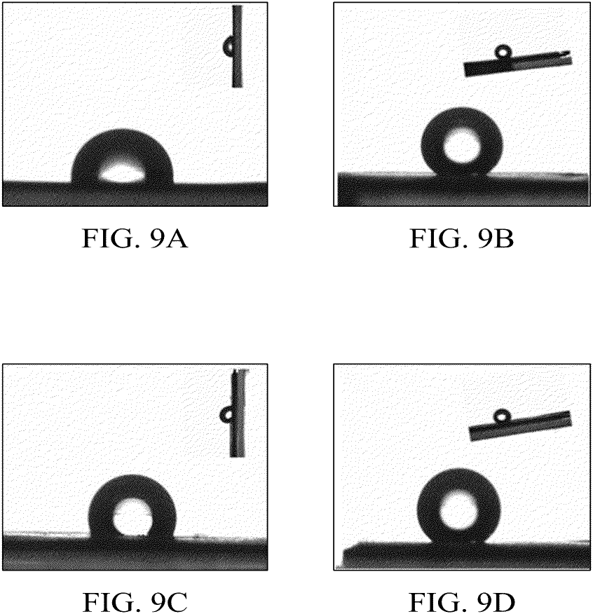

The wetting behavior of PVDF membranes cast on different substrates was evaluated using static water contact angle and sliding angles measured using an optical contact angle goniometer. Membrane samples were set flat under an optical lens and the contact angle measurement of water under a sessile drop method was taken at five distinct locations on the membrane. As shown in FIG. 8, the contact angle of a PVDF membrane that was cast on a glass substrate was around 97°, whereas the contact angle of PVDF membrane that was cast on sandpaper was around 115°. In contrast, the membranes that were cast with an SSM substrate or a PDMS substrate achieved a significant improvement in hydrophobicity with relatively high water contact angles of close to or above 150°. From these results, it was concluded that texturing membranes during the casting process by simply utilizing a suitable substrate enhanced the hydrophobicity of the resulting PVDF membrane. In addition to static contact angle, sliding angle at which the droplet moves over the membrane provides beneficial information regarding membrane wetting. Referring to FIG. 9, the sliding angles for glass and sandpaper based membranes was more than 90°, denoting adhesion of the water droplet on the membrane surface. On the other hand, the sliding angles of SSM and PDMS based membranes were determined to be approximately 10° and 13°, respectively. This relatively low value of sliding angle for SSM and PDMS coupled with their relatively high static water contact angles represented a superhydrophobic surface characteristic.

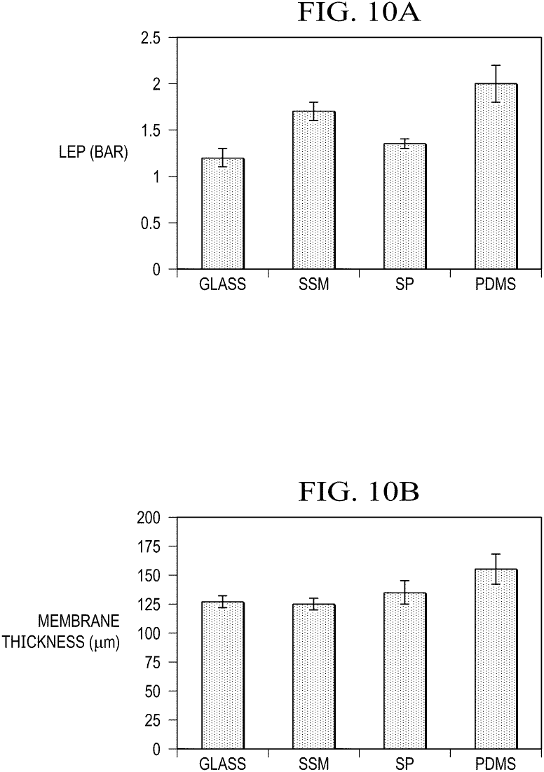

The membrane bulk property was evaluated using an LEP measurement which depended on the pore size and hydrophobicity of membranes. DI water was used and pressurized air was forced gradually into a chamber against the membrane facing textured surface. The pressure at which a fine droplet of water was observed on the underside the chamber was taken as LEP. Referring to FIG. 10A, at least three samples were tested to record the average value. The LEP of a PDMS based membrane exhibited the highest among the samples followed by SSM and sandpaper. The NIPS technique that was used was able to develop a membrane with LEP of at least 1.2 bar on glass, which is considered to be a base value for treating highly saline water. The thickness of a membranes is a significant variable for defining the flux in an AGMD test. Referring to FIG. 10B, each membrane had a thickness of about 125 µm except the PDMS based membrane which eventually had a greater thickness than other membranes. This was due to the PDMS substrate having additional inside features which gave the membrane more thickness than other samples while keeping the same initial casting thickness of 250 µm.

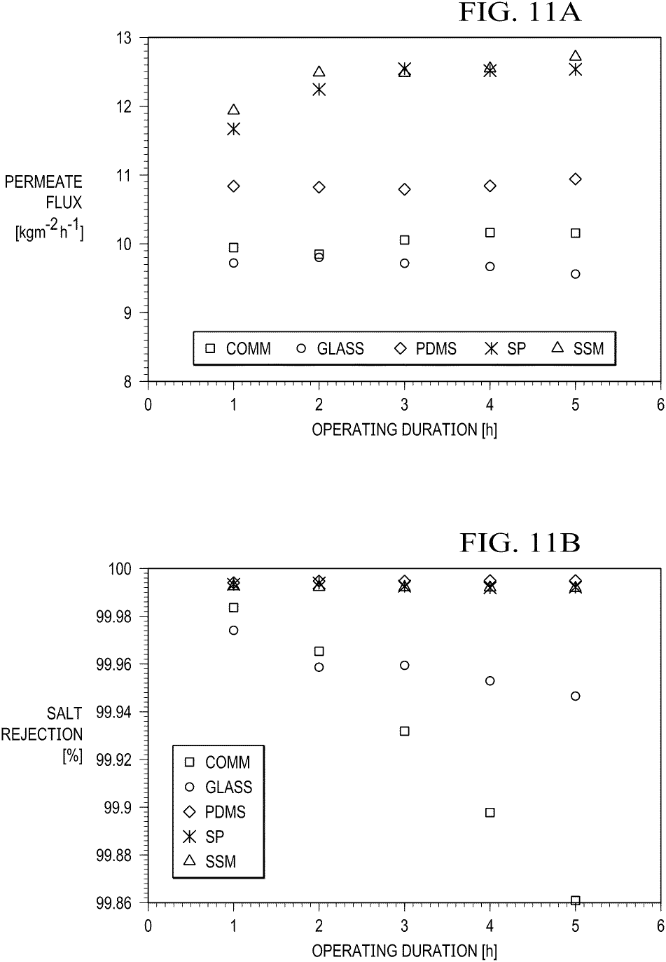

Desalination of highly saline feed water was performed using AGMD on the membranes fabricated. The results of the AGMD test for the membranes was also compared with a commercial PVDF membrane (TISCH Scientific) which had a LEP of 0.4±0.1 bar and a thickness of about 105 µm.The effect of different textures as determined by the different substrates (glass, SSM, sandpaper and PDMS) were investigated. FIGS. 11A and 11B show the permeate flux and the quality of freshwater (salt content) performance, respectively, of the prepared membranes and also of the commercial PVDF membrane (denoted as COMM). The tests were performed for five hours with 7.0 wt.% NaCl solution (70,000 ppm) as feed water under the operating condition of 70° C. feed temperature and 20° C. coolant temperature.

For a proper comparison, each tested membrane had a similar thickness, ranging between 125 and 155 µm, while the commercial PVDF had a thickness of 105 µm. As shown in FIG. 9A), after five hours all the textured membranes showed superior permeate fluxes when compared to the commercial PVDF membrane. In addition, both SSM and sandpaper exhibited the highest water fluxes with an average permeate flux of 12.5 kg/m2.h and 12.3 kg/m2.h, respectively. The superior permeate flux performance of the textured membranes could be attributed to their greater effective surface area due to their rough pattern, which provided a longer contact time between the membrane and the feed water. As shown in FIG. 11B, the prepared membranes maintained a relatively stable salt rejection performance when compared to the commercial PVDF membrane. As shown in FIG. 12, the textured membranes provided ultra-high quality permeated water. Referring to the FIG. 12 inset, the salt content was as low as 3.4 mg/L. The water quality for the commercial PVDF membrane decayed within the five hour test duration (11.4 - 97.3 mg/L), which was believed to be due to its relatively low water contact angle (91 ± 7°), corresponding to a relatively low hydrophobicity. As stated above, the textured SSM, sandpaper and PDMS-based membranes provided a rough pattern for texturing, which improved the hydrophobicity of the membrane, thereby providing more resistance to water penetration. The texturing as observed in SSM and PDMS substrates achieved a relatively high improvement in hydrophobicity with a high water contact angle close to and above 150°. Therefore, they provided stable wettability and maintain more stable salt rejection.

### II. Substantially Water-Free Alcohol as the Non-Solvent

### IIA. Membrane Preparation

PVDF powder with an average molecular weight of about 534,000, PVP powder with an average molecular weight of 10,000, and methanol were purchased from Sigma-Aldrich (USA). DMF was purchased from Scientific Laboratory Supplies (UK). Ethanol was purchased from DUKSAN reagents (Korea). Isopropanol was purchased from PanReac-Applichem (ITW Reagents). Sandpaper sheets of different grit sizes (220, 320 and 400) were locally purchased. Sylgard 184 (PDMS) and curing agent were acquired from DOW chemical company (USA).

A PDMS framework as a casting substrate was prepared using commercial sandpaper having a textured morphology to fabricate the superhydrophobic PVDF membranes. The commercial sandpaper sheet with textured morphology (grit size: 220, 320 and 400) was carefully taped on a plane glass sheet with the aid of double-sided tape for proper leveling and to avoid any gap between the sandpaper and glass sheet. Afterward, a wooden/plastic frame was attached to the sides of the sandpaper sheet taped on the glass surface. Sylgard 184 and curing agent (PDMS) were disposed with a ratio of 10:1 in a glass vial sealed with a proper cap, which was thoroughly stirred with a magnetic stirrer. This liquid mixture was casted on a sandpaper sheet taped on glass surface with the help of casting knife and then carefully kept in a heating oven at 80° C. for four hours to solidify the PDMS layer. After proper solidification of the PDMS layer, the layer was carefully peeled off of the sandpaper sheet so that the surface of the PDMS layer had the opposite impression of sandpaper. This PDMS sheet was thoroughly cleaned and used as the casting substrate.

The superhydrophobic polyvinylidene fluoride (PVDF) membranes were fabricated in a single step via phase inversion technique using PDMS casting substrates having a textured morphology of a commercial sandpaper (grit size: 220, 320 or 400). For the fabrication of superhydrophobic polymeric PVDF membranes, initially a 15% PVDF solution was prepared in DMF in a closed glass bottle using magnetic stirring at 40° C. for 24 hours, and then 5% PVP the as pore forming agent was added to the solution, followed by further stirring for 24 hours under the same conditions. The PVDF/PVP casting solution was casted on different textured PDMS substrates using a doctor blade. The casted PVDF/PVP solution on textured the PDMS substrate was dipped in first a coagulation bath (in which the solvent was ethanol, isopropanol or methanol) for two minutes at room temperature and then placed in a second coagulation bath formed of DI water for complete polymerization of the membrane for 24 hours at room temperature. Subsequently, the PVDF membrane was detached from the textured PDMS substrate. After 24 hours, the polymerized PVDF membrane was removed from the second coagulation bath and cleaned two or three times with DI water. Afterward, the PVDF membrane was allowed to dry in air for 24 hours.

All membranes were fabricated using a first coagulation bath that had one of three different solvents (ethanol, isopropanol and methanol). The PVDF membranes synthesized in ethanol, isopropanol and methanol on glass substrate were marked as PVDF@Glass-ETh, PVDF@Glass-ISP and PVDF@Glass-MTh respectively. Similarly, the PVDF membranes synthesized in ethanol, isopropanol and methanol on a textured PDMS substrate having pattern of 220, 320 and 400 grit size sandpaper were marked as: PVDF@220PDMS-ETh, PVDF@220PDMS-ISP and PVDF@220PDMS-MTh; PVDF@320PDMS-ETh, PVDF@320PDMS-ISP and PVDF@320PDMS-MTh; and PVDF@400PDMS-ETh, PVDF@400PDMS-ISP and PVDF@400PDMS-MTh, respectively.

### IIB. Experimental Results

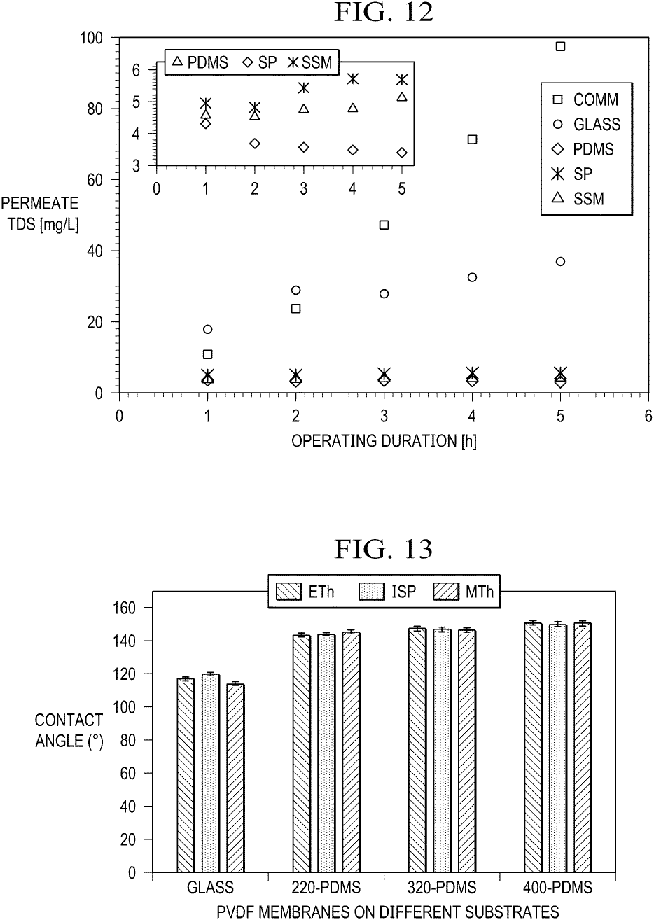

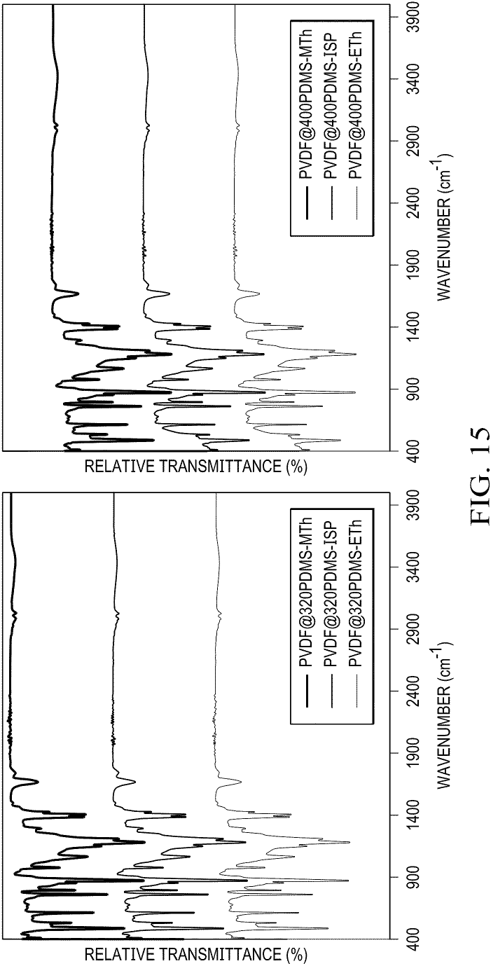

The surface wetting and non-wetting behavior of the polymeric PVDF membranes, fabricated on different substrates were measured using a KRUSS (Germany) goniometer. The Sessile drop method was used to measure the water contact angle on the membrane surface. Accordingly, a 5 µL water droplet at room temperature was placed carefully on the membrane surface with the help of controlled syringe and its image was subsequently captured. In order to obtain an estimate for the average value, a contact angle estimation was carried out on various locations of the membrane surfaces. The membranes were taped on the flat glass surface with the assistance of double sided tape for exact quantification. The surface wettability of PVDF membranes fabricated on a smooth glass surface and on PDMS casting substrate having texture of 220, 320 and 400 grit sizes sandpapers using different solvents are depicted in FIG. 13. The results of contact angle measurements illustrate the hydrophobic nature of the PVDF membranes (PVDF@Glass-ETh, PVDF@Glass-ISP and PVDF@Glass-MTh) fabricated on a smooth glass substrate by phase inversion method using ethanol, isopropanol and methanol as solvents. The water contact angle of PVDF@Glass-ETh, PVDF@Glass-ISP and PVDF@Glass-MTh membranes were 117°, 120° and 114°, respectively. The textured PVDF membranes, fabricated on the PDMS substitute the having texture of 220 grit size sandpaper (PVDF@220PDMS-ETh, PVDF@220PDMS-ISP and PVDF@220PDMS-MTh) and 320 grit size sandpaper (PVDF@320PDMS-ETh, PVDF@320PDMS-ISP and PVDF@320PDMS-MTh) were highly hydrophobic (water contact angle > 145°). The PVDF membranes fabricated on 400 grit size sandpaper (PVDF@400PDMS-ETh, PVDF@400PDMS-ISP and PVDF@400PDMS-MTh) were superhydrophobic (water contact angle > 150°). The contact angle values of all the textured and non-textured PVDF membranes are given in Table 1 (below). Table 1 and FIG. 15 (see discussion below) show that the hydrophobicity of the textured PVDF membranes increased by increasing the fine patterned grit size number PDMS casting substrate. Additionally, the superhydrophobic nature of the textured PVDF membranes (PVDF@400PDMS-ETh, PVDF@400PDMS-ISP and PVDF@400PDMS-MTh) could be highly beneficial for long-term usage for treatment of highly saline water using membrane distillation technology.

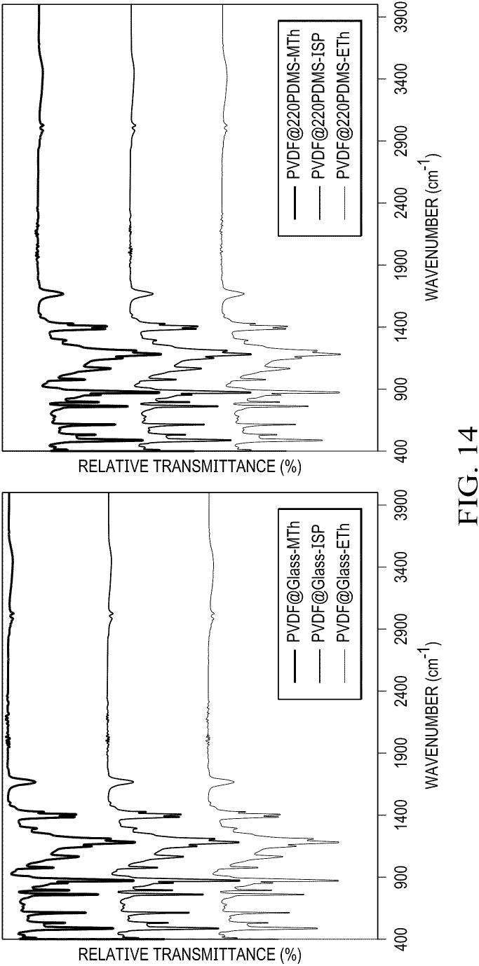

FT-IR spectroscopic analysis of the PVDF membranes was carried out under ATR mode to know the functional group or vibrational mode present in the prepared membrane samples. The FT-IR spectrum of PVDF membranes fabricated on a smooth glass surface and on a PDMS surface having texture of 220, 320 and 400 grit size sandpapers using different solvents (ethanol, isopropanol and methanol) are shown in FIGS. 14 and 15. In the FT-IR spectra of PVDF membranes fabricated in ethanol, isopropanol and methanol on smooth glass surface, the absorption peaks at wavenumbers 871.37 cm⁻¹ and 854.02 cm⁻¹ were attributed to the amorphous phase of the PVDF polymer and the absorption peak at 1064.78 cm-1 was attributed to the crystalline phases of the PVDF polymer. Other main absorption peaks at 1180.24 cm⁻¹ and 1402.48 cm⁻¹ were attributed to the -CF2 group stretching vibrations and bending mode of C-H bonds, respectively. The characteristic peaks of PVDF polymer were found almost at the same wavenumber values in the FT-IR spectrum of all the membrane samples (FIGS. 14 and 15), fabricated at 220 grit size sandpaper (PVDF@220PDMS-ETh, PVDF@220PDMS-ISP and PVDF@220PDMS-MTh), 320 grit size sandpaper (PVDF@320PDMS-ETh, PVDF@320PDMS-ISP and PVDF@320PDMS-MTh) and 400 grit size sandpaper (PVDF@400PDMS-ETh, PVDF@400PDMS-ISP and PVDF@400PDMS-MTh) in different solvents.

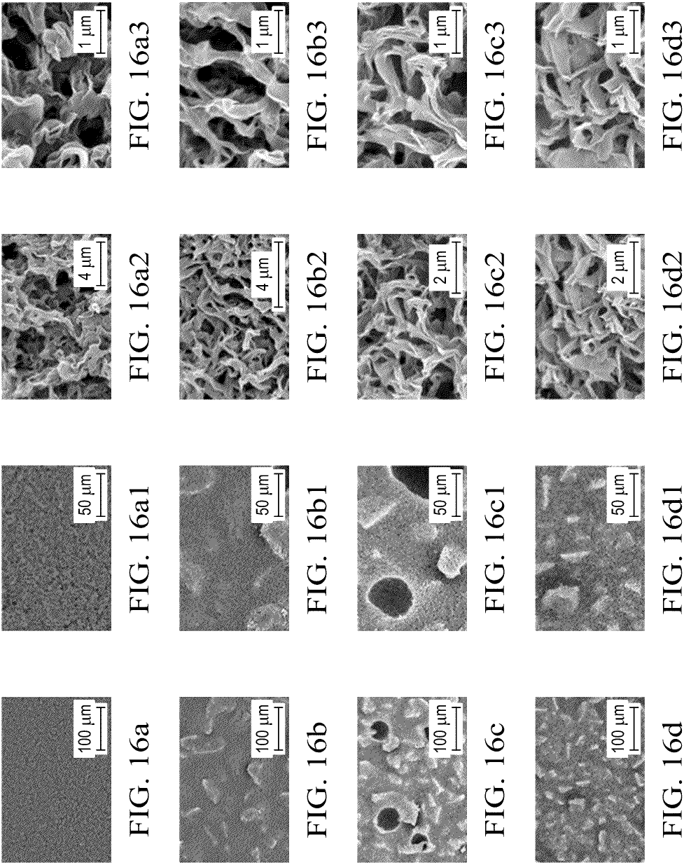

The surface morphological analysis of the PVDF membranes fabricated on different substrates by phase inversion method using different solvents were investigated by field emission scanning electron microscopy (FE-SEM). FIG. 16a-16d3 shows the FE-SEM images of PVDF membranes fabricated using ethanol as the first coagulation bath on clean glass substrate (PVDF@Glass-ETh) and on various PDMS substrate having characteristic pattern of 220, 320 and 400 sandpaper sheets (PVDF@220PDMS-ETh, PVDF@320PDMS-ETh and PVDF@400PDMS-ETh) at different magnifications. The images of PVDF@Glass-ETh are shown in FIG. 16a-16a3. The images of PVDF@220PDMS-ETh are shown in FIG. 16b- 16b3. The images of PVDF@320PDMS-ETh are shown in FIG. 16c-16c3. The images of PVDF@400PDMS-ETh are shown in FIG. 16d-16d3. Low and high magnification FE-SEM images of the PVDF@Glass-ETh membrane clearly display the smooth and fibrous morphology, respectively. However, low magnification FE-SEM images of the PVDF@220PDMS-ETh, PVDF@320PDMS-ETh and PVDF@400PDMS-ETh membranes demonstrate the characteristic texturing of 220, 320 and 400 sandpaper sheets, respectively, on polymeric PVDF membranes with hierarchical roughness. It is also evident from FIG. 16a-16d3 that the pattern/texturing of sandpaper sheets on PVDF membranes were denser by utilizing the higher grit size sandpaper textured PDMS framework as a casting substrate. In addition, high magnification FE-SEM images of the PVDF@220PDMS-ETh, PVDF@320PDMS-ETh and PVDF@400PDMS-ETh membranes showed the fibrous and porous morphology.

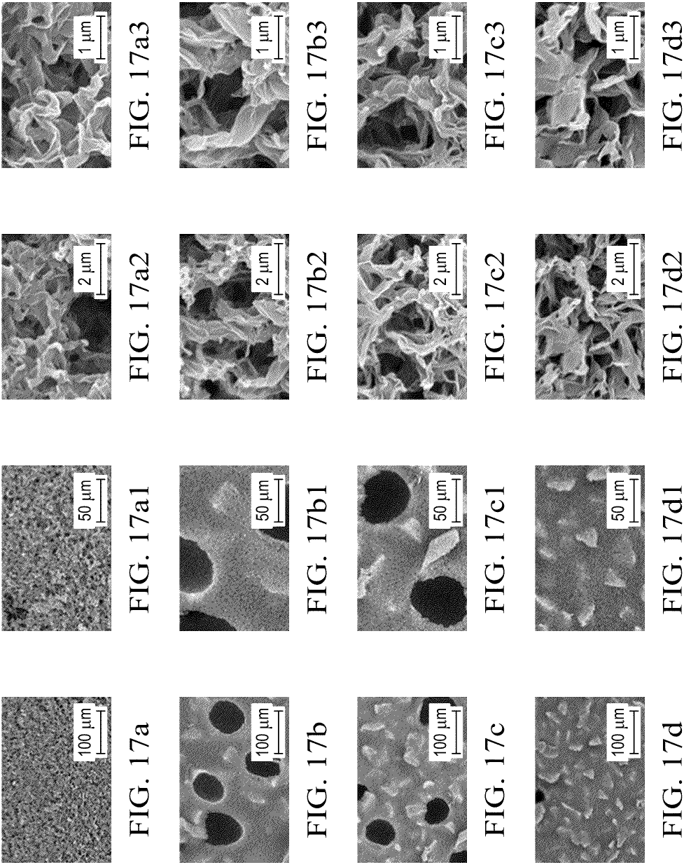

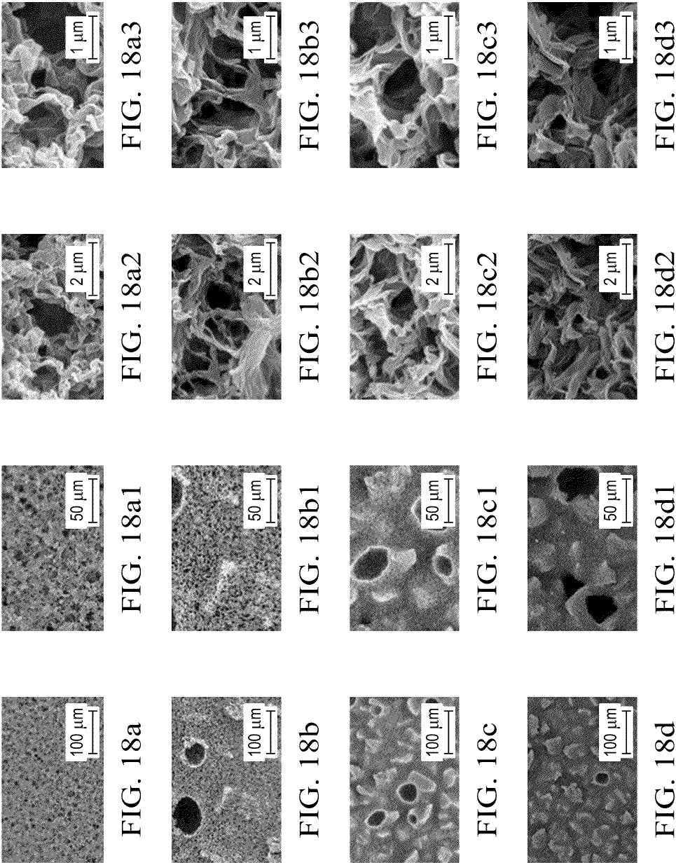

Similarly, the surface morphology of PVDF membranes fabricated using isopropanol and methanol as the first coagulation bath on a clean glass substrate (PVDF@Glass-ISP and PVDF@Glass-MTh) and on various PDMS substrate having characteristic pattern of 220, 320 and 400 sandpaper sheets (PVDF@220PDMS-ISP, PVDF@320PDMS-ISP and PVDF@400PDMS-ISP; PVDF@220PDMS-MTh, PVDF@320PDMS-MTh and PVDF@400PDMS-MTh) were also carried out using FE-SEM at different magnifications. Images of PVDF@Glass-ISP are shown in FIG. 17a-17a3. Images of PVDF@220PDMS-ISP are shown in FIG. 17b-17b3. Images of PVDF@320PDMS-ISP are shown in FIG. 17c-17c3. Images of PVDF@400PDMS-ISP are shown in FIG. 17d-17d3. Images of PVDF@Glass-MTh are shown in FIG. 18a-18a3. Images of PVDF@220PDMS-MTh are shown in FIG. 18b-18b3. Images of PVDF@320PDMS-MTh are shown in FIG. 18c-18c3. Images of PVDF@400PDMS-MTh are shown in FIG. 18d-18d3. The surface morphology of the textured membranes, fabricated using isopropanol (FIG. 17a-17d3) and methanol (FIG. 18a-18d3) are similar to the morphology of the textured membranes, fabricated using ethanol (FIG. 16a-16d3). Therefore, the existence of characteristic surface texturing of sandpaper sheets and the existence of mountain and valleys like hierarchal or pyramidal structures on the membrane surfaces reveal the successful surface texturing on polymeric PVDF membranes via the phase inversion technique using highly efficient and sustainable PDMS casting substrates having textured morphology of the commercial sandpaper sheets.

Liquid entry pressure (LEP) is a relevant characteristic of membrane distillation membranes. LEP of the PVDF membranes fabricated on different substrates by phase inversion method using different solvents were determined by laboratory made setup. The LEP values of the various textured and non-textured PVDF membranes, measured by laboratory made setup are given in Table 1 (below). From Table 1, it is clear that the LEP values of the PVDF membranes fabricated on glass substrate (PVDF@Glass-ETh, PVDF@Glass-ISP and PVDF@Glass-MTh) were higher than the textured PVDF membranes fabricated on different PDMS casting substrates having textured morphology of the commercial 220, 320 and 400 grit size sandpaper sheets, may be due to the smaller pore size of the PVDF membranes fabricated on glass substrate.

TABLE 1

| Membrane Samples | Contact Angle (°) | Liquid Entry Pressure (bar) | Thickness (µm) |
|---|---|---|---|
| On Glass Substrate | | | |
| PVDF@Glass-ETh | 117 | 2.10 | 252 |
| PVDF@Glass-ISP | 120 | 1.85 | 234 |
| PVDF@Glass-MTh | 114.20 | 2.05 | 236 |
| On PDMS Substrate having 220 Grid Sandpaper Texture | | | |
| PVDF@220PDMS-ETh | 143.59 | 1.95 | 315.25 |
| PVDF@220PDMS-ISP | 144.10 | 1.80 | 290.25 |
| PVDF@220PDMS-MTh | 145.40 | 2.25 | 318.25 |
| On PDMS Substrate having 320 Grid Sandpaper Texture | | | |
| PVDF@320PDMS-ETh | 147.58 | 1.75 | 335 |
| PVDF@320PDMS-ISP | 146.70 | 1.5 | 310.5 |
| PVDF@320PDMS-MTh | 146.90 | 1.4 | 363.25 |
| On PDMS Substrate having 440 Grid Sandpaper Texture | | | |
| PVDF@400PDMS-ETh | 150.90 | 1.5 | 342 |
| PVDF@400PDMS-ISP | 150.80 | 1.6 | 307 |
| PVDF@400PDMS-MTh | 150 | 1.6 | 377.5 |

Other embodiments are encompassed within the claims.

What is claimed is:

1. A method, comprising:
forming a PDMS substrate on a surface of sandpaper;
disposing a hydrophobic polymer and PVP in DMF to form a solution;
disposing the solution on a surface of the PDMS substrate to provide a first intermediate product; and
disposing the first intermediate product in a substantially water-free alcohol solution to provide a second intermediate product.

2. The method of claim 1, wherein the hydrophobic polymer comprises PVDF.

3. The method of claim 1, wherein the suspension comprises from 13% to 17% PVDF, and from 4% to 7% pore former.

4. The method of claim 3, wherein the alcohol comprises a member selected from the group consisting of ethanol, isopropanol and methanol.

5. The method of claim 4, wherein the hydrophobic polymer comprises PVDF.

6. The method of claim 1, wherein the alcohol comprises a member selected from the group consisting of ethanol, isopropanol and methanol.

7. The method of claim 6, wherein the hydrophobic polymer comprises PVDF.

8. The method of claim 1, further comprising disposing the second intermediate product in water to form a solid hydrophobic polymer film on the PDMS substrate.

9. The method of claim 8, further comprising removing the solid hydrophobic polymer film from the PDMS substrate to provide a membrane comprising the solid hydrophobic polymer.

10. The method of claim 9, wherein at least one of the following holds:
the surface of a surface of the membrane has a grit that is substantially the same as a grit of the surface of the sandpaper;
the surface of a surface of the membrane has an Ra value that is substantially the same as an Ra of the surface of the sandpaper;
the surface of a surface of the membrane has an Rq value that is substantially the same as an Rq of the surface of the sandpaper;
the surface of a surface of the membrane has an Rz that is substantially the same as an Rz value of the surface of the sandpaper.

11. The method of claim 1, wherein at least one of the following holds:
the polymer film comprises pores, and the pores have an average size of from 0.1 µm to 0.3 µm;
the polymer film comprises a surface having a static water contact angle of from 143° to 151°;
the polymer film has a liquid entry pressure of from 1.4 bar to 2.25 bar; and
the polymer film has a thickness of from 290 µm to 380 µm.

12. The method of claim 1, wherein the second intermediate produce comprises a solid sheet of the hydrophobic polymer, and the method further comprises forming a porous membrane of the hydrophobic polymer.

13. The method of claim 12, further comprising disposing the PVDF film in a membrane distillation module.

14. The method of claim 13, further comprising using the membrane distillation module in a method selected from the group consisting of direct contact membrane distillation, air gap membrane distillation, sweeping gas membrane distillation, vacuum gap membrane distillation, permeate gap membrane distillation and vacuum multi-effect membrane distillation.

15. The method of claim 14, further comprising using the membrane distillation module to treat produced water.

16. The method of claim 14, further comprising using the membrane to treat produced water via an air gap membrane desalination process.

17. A method, comprising:
disposing PDMS on a surface of sandpaper to use the surface of the sandpaper as a substrate to form a PDMS substrate;
solidifying the PDMS on the surface of the sandpaper;
removing the solidified PDMS substrate from the sandpaper so that the solidified PDMS has a surface that substantially matches the surface of the sandpaper;
disposing PVDF and PVP in DMF to form a solution comprising from 13% to 17% PVDF and from 4% to 7% PVP;
disposing the solution on the surface of the PDMS substrate to provide a first intermediate product;
disposing the first intermediate product in substantially a water-free solution comprising an alcohol selected from the group consisting of ethanol, isopranol and methanol to provide a solidified PVDF film on the surface of the PDMS;
disposing the PVDF film-PDMS in water; and
after disposing the second intermediate product in water, removing the PVDF film from the PDMS to provide a PVDF sheet.

18. The method of claim 17, further comprising washing and drying the PVDF sheet to provide a porous and hydrophobic PVDF membrane.

19. The method of claim 18, further comprising using the membrane in a membrane distillation process.

20. The method of claim 19, wherein the membrane distillation process comprises a process selected from the group consisting of direct contact membrane distillation, air gap membrane distillation, sweeping gas membrane distillation, vacuum gap membrane distillation, permeate gap membrane distillation and vacuum multi-effect membrane distillation.
